(19) United States
(12) Patent Application Publication
(10) Pub. No.: US 2006/0040008 A1
(43) Pub. Date: Feb. 23, 2006

(54) Device for the continuous production of a nonwoven web

(75) Inventors: Hans-Georg Geus, Niederkassel (DE); Detlef Frey, Niederkassel (DE); Hans-Peter Schlag, Troisdorf (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: REIFENHAEUSER GMBH & CO. KG MASCHINENFABRIK, Troisdorf (DE)

(21) Appl. No.: 11/183,857

(22) Filed: Jul. 19, 2005

(30) Foreign Application Priority Data
Aug. 20, 2004 (DE) 10 2004 040 645.6
Dec. 3, 2004 (EP) 04 028 714.6

(51) Int. Cl. B28B 5/00

(52) U.S. Cl. 425/72.2

(57) ABSTRACT

Device for the continuous production of a nonwoven web from filaments made from a thermoplastic synthetic, with a spinning nozzle, a cooling chamber, a stretching unit and a depositing device for depositing the filaments to the nonwoven web. Two or more different polymer fusions can be fed to the spinning nozzle, and a device for merging the different polymer fusions is provided such that bi-component filaments and multi-component filaments can exit from the spinning nozzle openings of the spinning nozzle. The cooling chamber is divided into at least two cooling chamber sections in which the bi-component filaments and multi-component filaments can be respectively acted upon by process air with different convective heat conduction means.

The invention relates to a device for the continuous production of a nonwoven web from filaments made from a thermoplastic synthetic, with a spinning nozzle, a cooling chamber, a stretching unit and a depositing device for depositing the filaments to the nonwoven web.

A known device of the type specified above (EP 1 340 843 A1), which is the starting point for this invention, has basically proven to be of value for the production of a nonwoven web from aerodynamically stretched monofilaments. Unlike other known devices of this type, the filament speed and the filament fineness can be surprisingly increased here when producing a nonwoven web. In this way, higher filament flow rates and filaments with finer titres can be obtained.

The problem which forms the basis of the invention is to provide a device of the type specified at the start whereby, with high filament speed and so high flow rates, and with high levels of filament fineness, the properties of the filaments and so the properties of the resulting nonwoven webs can be variable and specifically set.

In order to solve this technical problem, the invention proposes a device for the continuous production of a nonwoven web made from thermoplastic synthetic filaments,—with a spinning nozzle, a cooling chamber, a stretching unit and a depositing device for depositing the filaments to the nonwoven web,

whereby two or more different polymer fusions can be fed to the spinning nozzle, and whereby a device for merging the different polymer fusions is provided, such that bi-component filaments or multi-component filaments exit from the spinning nozzle openings of the spinning nozzle,

and whereby the cooling chamber is divided into at least two cooling chamber sections in which the bi-component filaments or multi-component filaments come into contact respectively with different convective heat discharge means.—The term process air means cooling air for cooling the filaments. Within the framework of the invention, process air with different convective heat discharge means means in particular process air with a different temperature and/or with a different air humidity.

Within the framework of the invention, the term different polymer fusions means in particular fusions of different polymers, for example of two different polyolefins. Also within the framework of the invention, however, the term also basically means different polymer fusion fusions of one and the same polymer with different properties, for example different molecular weights, molecular weight distributions and rheological and chemical properties. A device for merging the different polymer fusions means in particular a distribution unit or a distribution plate with the help of which the different polymer fusions are merged so that they exit from the spinning nozzle openings as bi-component filaments or multi-component filaments.—In accordance with a highly favoured embodiment of the invention, the device in accordance with the invention for producing bi-component filaments which consist of two different polymers is provided.

Preferably, the device for merging the different polymer fusions is designed such that bi-component filaments or multi-component filaments with a side to side configuration and/or with a core-shell configuration can be produced. Although both of the aforementioned configurations are favoured, it is nonetheless within the framework of the invention that, with the device in accordance with the invention, other configurations of bi-component filaments or multi-component filaments can also be produced, for example so-called segmented pie filaments or island in the sea filaments.

It is within the framework of the invention that the bi-component filaments or the multi-component filaments respectively come into contact with process air of a different temperature in the at least two cooling chamber sections. The invention is based upon the knowledge that, with a device in accordance with the invention which has, as well as the other device components in question, on the one hand the device for producing bi-component filaments, and on the other hand the cooling chamber in accordance with the invention with different temperatures acting upon these filaments, a surprisingly variable, specific and reproducable setting of the filament properties and so of the resulting nonwoven webs is possible. The set properties are in particular the strength, in particular the tensile strength and/or the extension and/or the flexural stiffness and/or the bagginess and/or the suppleness and/or the textile grip and/or the drape behaviour of the nonwoven webs produced.

Advantageously, at least two cooling chamber sections are provided beneath the spinning nozzle, arranged vertically over one another, in which the bi-component filaments or the multi-component filaments respectively come into contact with process air of a different temperature. Preferably, only two cooling chamber sections are arranged vertically over one another. After exiting from the spinning nozzle openings, the bi-component filaments or the multi-component filaments then first of all pass through a first, upper cooling chamber section, and then through a second, lower cooling chamber section.

The invention is based upon the knowledge that bi-component filaments and multi-component filaments require different procedural process management than do monofilaments. The device in accordance with the invention is ideally suited for this special process management. The different polymers in bi-component filaments and multi-component filaments have different rheological properties and different fusion points, glass transition points, specific heat capacities and crystallisation speeds. If one brings these polymers in different configurations and in different mass ratios together, in order to achieve required filament finenesses and required physical filament properties, the process management must be specially set dependent upon the different compositions. In connection with this within the framework of the invention, the exit speeds of the process air from the cooling chamber sections and the temperature and/or the air humidity of the process air can be set and is adjustable.

In accordance with a preferred embodiment of the invention, the temperature of the process air is higher in a first, upper cooling chamber section than the temperature of the process air in a second, lower cooling chamber section. Preferably, the temperature of the process air in the first, upper cooling chamber section is higher than the temperature of the process air in the second, lower cooling chamber section when the device is set up to produce bi-component filaments or multi-component filaments, the components of which consist exclusively of polyolefins or exclusively of polyolefins and polyesters.

In accordance with one embodiment of the invention, the temperature of the process air in the first, upper cooling chamber section is 20 to 45° C., preferably 22 to 40° C., and ideally 25 to 35° C., and the temperature of the process air in the second, lower cooling chamber section is 10 to 30° C., preferably 15 to 25° C., and ideally 17 to 23° C. when the device is set up to produce bi-component filaments or multi-component filaments, the components of which consist exclusively of polyolefins. It is within the framework of the invention that the temperature of the process air in the first, upper cooling chamber section is approximately 35° C., and the temperature of the process air in the second, lower cooling chamber section is approximately 20° C. Within the framework of the invention, the term polyolefin means in particular polyethylene or polypropylene.

The above temperature ratios are set for example when the device is set up to produce bi-component filaments which contain as components polypropylene on the one hand and polyethylene on the other hand. These bi-component filaments have in particular a side to side configuration or a core-shell configuration.

In accordance with another embodiment of the invention, the temperature of the process air in the upper cooling chamber section is 50 to 90° C., preferably 55 to 85° C., and ideally 60 to 80° C., and the temperature of the process air in the second, lower cooling chamber section is 10 to 40° C., preferably 15 to 35° C., and ideally 15 to 25° C. when the device is set up to produce bi-component filaments or multi-component filaments, the components of which consist on the one hand of polyolefins, and on the other hand of polyesters. Advantageously, the temperature in the first, upper cooling chamber section can then be approximately 70° C., and the temperature of the process air in the second, lower cooling chamber section can be approximately 20° C. The above temperature ratios are in particular set when the device is set up to produce bi-component filaments of which one component consists of a polyolefin, and the other components consist of a polyester. Within the framework of the invention, polyester above all means polyethylene terephthalate (PET). In accordance with one embodiment of the invention, the above temperature ratios are set for producing bi-component filaments of which one component consists of polyethylene, and of which the other components consist of polyethylene terephthalate (PET).

In accordance with another preferred embodiment of the invention, the temperature of the process air in the first, upper cooling chamber section is lower than the temperature of the process air in the second, lower cooling chamber section when the device is set up to produce bi-component filaments or multi-component filaments, the components of which consist exclusively of polylactides and polyolefins, or exclusively of polyvinyl alcohols and polyolefins, or exclusively of polyvinyl alcohols and polyesters. In particular, these can be bi-component filaments of which one component consists of a polylactide, and of which other components consist of a polyolefin, or of which one component consists of a polyvinyl alcohol, and of which other components consist of a polyolefin, or of which one component consists of a polyvinyl alcohol and of which other components consist of a polyester. Within the framework of the invention, with these embodiments (in accordance with patent claim 7), the temperature of the process air in the first, upper cooling chamber section 7 is max. 25°, preferably 10 to 25° C., and ideally 15 to 25° C., whereas the process air in the second, lower cooling chamber section is 15 to 40° C., preferably 15 to 35° C., and ideally 17 to 25° C., always with the proviso that the temperature of the process air in the first, upper cooling chamber section is lower than the temperature of the process air in the second, lower cooling chamber section. Moreover, when the device is used to produce bi-component filaments or multi-component filaments, the components of which consist exclusively of polyvinyl alcohols and polyolefins, or exclusively of polyvinyl alcohols and polyesters, these filaments advantageously have a segmented pie configuration. When the device is used to produce bi-component filaments or multi-component filaments, the components of which consist exclusively of polylactides and polyolefins, in accordance with a preferred embodiment, the filaments have a core-shell configuration, whereby the lactide component is located in the shell.

In accordance with a particularly preferred embodiment of the invention, the device is set up such that the exit speed of the process air from the first, upper cooling chamber section into the second, lower cooling chamber section is less than the exit speed of the process air from the second, lower cooling chamber section into the stretching unit or into the intermediary channel. Within the framework of the invention here, the exit speed of the process air from the first, upper cooling chamber section into the second, lower cooling chamber section is 1.0 to 1.6 m/sec, preferably 1.1 to 1.5 m/sec, and ideally 1.2 to 1.4 m/sec. Furthermore, within the framework of the invention the exit speed of the process air from the second, lower cooling chamber section into the stretching unit or into the intermediary channel is 1.5 to 2.1 m/sec, preferably 1.5 to 2.0 m/sec, and ideally 1.7 to 1.9 m/sec. Advantageously, the v1/v2 ratio of the exit speed v1 of the process air from the first, upper cooling chamber section into the second, lower cooling chamber section to the exit speed v2 of the process air from the second, lower cooling chamber section into the stretching unit or into the intermediary channel is 0.9 to 0.5, preferably 0.85 to 0.6, and ideally 0.8 to 0.7.—It is basically also within the framework of the invention that the exit speed of the process air from the first, upper cooling chamber section into the second, lower cooling chamber section is greater than the exit speed of the process air from the second, lower cooling chamber section into the stretching unit or into the intermediary channel. In this respect, one embodiment of the invention is characterised in that the ratio v1/v2 of the exit speed v1 of the process air from the first, upper cooling chamber section into the second, lower cooling chamber section to the exit speed v2 of the process air from the second, lower cooling chamber section into the stretching unit or into the intermediary channel is 1.3 to 0.5.

In accordance with another embodiment of the invention, the exit speed of the process air from the first, upper cooling chamber section into the second, lower cooling chamber section is greater than the exit speed of the process air from the second, lower cooling chamber section into the stretching unit or into the intermediary channel. The ratio v1/v2 of the exit speed v1 to the exit speed v2 is then advantageously 1.2 to 1.8, preferably 1.3 to 1.7 and ideally 1.4 to 1.6.—The embodiment described first, whereby the exit speed v1 is less than the exit speed v2 has proven to be of particular value. With this embodiment, particularly fine bi-component filaments and multi-component filaments can be produced.

Advantageously, the air feed cabin located next to the cooling chamber is divided into at least two cabin sections from which process air of a different temperature and/or different air humidity can be respectively fed into the allocated cooling chamber section. The air feed cabin here consists of at least two cabin sections arranged vertically over one another. Advantageously, only two cabin sections are arranged vertically over one another. It is within the framework of the invention, therefore, that the first and the second cabin sections are arranged vertically over one another, and the first cabin section here forms the upper cabin section, and the second cabin section forms the lower cabin section. Preferably, at least one blower is attached to each cabin section for feeding process air. It is within the framework of the invention that the temperature of each cabin section can be regulated. It is also within the framework of the invention that the volume flows to the individual cabin sections can be regulated to the air flows being fed. By setting the volume flow and the temperature, in particular of the upper cabin section, the cooling of the filaments can be reduced such that higher filaments speeds are possible, and finer filaments can be spun.

With units known from the prior art, the air feed cabin is generally referred to as a blower cabin. With these units, the filaments or the filament bundle have air blown specifically over them. It is within the framework of the invention that with the unit in accordance with the invention, no blowing over the filaments or the filament bundle takes place. Rather the process air is preferably sucked in by the filaments or the filament curtain. In other words, the filament bundle sucks in the process air which it needs. It is thus within the framework of the invention that the cooling chamber corresponds to a passive system where blowing air over the filaments does not take place, but only a sucking in of process air from the cabin sections. A barrier layer of air forms concentrically around the individual filaments respectively, and due to the structure of these barrier layers, the filaments or the filament bundle suck's in the process air. The barrier layers guarantee a sufficient distance between the filaments. Because active blowing is dispensed with, it can be an effective addition, that the filaments have no possibilities for deflecting in a troublesome manner, and no troublesome relative movements of the filaments in relation to one another take place.—Between the cooling chamber and the cabin sections, waver rectifiers are advantageously provided.

In accordance with a highly favoured embodiment of the invention, the ratio of the length of the first, upper cooling chamber section to the length of the second, lower cooling chamber section is 0.15 to 0.6, preferably 0.2 to 0.5, and ideally 0.2 to 0.4. The above length ratio applies in particular with a constant cross-section or with a constant cross-sectional area of the cooling chamber sections along the flow direction of the filaments.

Cross-sectional area means here the surface at right angles to the flow direction of the filaments. Correspondingly, the values given above for the length ratios also apply for the volume ratios of the two cooling chamber sections. Preferably, the second, lower cooling chamber section is approximately 3 times as long as or has approximately 3 times the volume of the first, upper cooling chamber section. The above length ratios and volume ratios have proven to be of particular value when producing bi-component filaments and multi-component filaments. With these length ratios and volume ratios, very fine bi-component filaments and multi-component filaments can be obtained, and in addition, these ratios mean that the properties of these filaments can be set very specifically and reproducably.

Due to the division of the cooling chamber, in accordance with the invention, into cooling chamber sections and the division of the air feed cabin into cabin sections, and because of the possibility of feeding air flows with different temperatures and different volume flows, an effective separation or decoupling of the “spinning, cooling” area from the “stretching, pulling” area can be achieved. In other words, the influences which pressure changes in the stretching unit have upon the conditions in the cooling chamber can be largely compensated by the measures taken in accordance with the invention. This aerodynamic separation is also backed up and facilitated by additional features in accordance with the invention, dealt with in the following.

It is within the framework of the invention that the cooling chamber is positioned a distance away from the nozzle plate of the spinning nozzle, and that the cooling chamber is advantageously positioned several centimetres below the nozzle plate. In accordance with a highly favoured embodiment of the invention, a monomer suction device is located between the nozzle plate and the air feed cabin. The monomer suction device sucks air out of the filament formation space directly beneath the nozzle plate, and in this way the gases exiting next to the polymer filaments can be removed from the unit as monomers, oligomers, decomposition products and similar. Moreover, with the monomer suction device, the air flow beneath the nozzle plate can be controlled. This could not remain stationary otherwise due to the indifferent ratios. The monomer suction device advantageously has a suction chamber to which preferably at least one suction blower is attached. Preferably, the suction chamber has a first suction slit in its lower section which leads into the filament formation space. In accordance with a highly favoured embodiment, the suction chamber also has in its upper section a second suction slit. By sucking through this second suction slit it can be effectively avoided that troublesome turbulence in the area between the nozzle plate and the suction chamber forms. Advantageously, the volume flow sucked out by the monomer suction device can be regulated.

It is within the framework of the invention that an intermediary channel is located between the cooling chamber and the stretching unit, and this intermediary channel converges in a wedge shape in the vertical section from the exit from the cooling chamber to the entrance into the pulling channel of the stretching unit. Advantageously, the intermediary channel converges in a wedge shape to the entrance into the pulling channel in the vertical section to the entrance width of the pulling channel. Preferably, different gradient angles of the intermediary channel can be set. It is within the framework of the invention that the geometry of the intermediary channel can be changed so that the air speed can be increased. In this way, undesired relaxations of the filaments which occur with high temperatures can be avoided.

The invention is based upon the knowledge that the above specified technical problem can be effectively solved if the measures in accordance with the invention are implemented. Essential for this solution to the technical problem is among other things an aerodynamic separation of the cooling of the filaments from the stretching of the filaments which is achieved by implementing the features described in accordance with the invention. Essential to the invention for this is first of all the formation in accordance with the invention of the cooling chamber and the air feed cabin, and also the possibility of regulating different temperatures and volume flows of the air being fed. The other measures in accordance with the invention explained above also contribute, however, to the aerodynamic separation. Within the framework of the invention, it is possible to separate and aerodynamically separate the filament cooling from the filament stretching while maintaining reliable function. Aerodynamic separation here means that pressure changes in the stretching unit have an effect upon the conditions in the cooling chamber, but however that the setting possibilities in the divided air feed can largely compensate this effect upon the fibres.—In combination with the aerodynamic separation, and in particular in combination with the setting possibilities in the cooling chamber, the use of bi-component filaments and multi-component filaments takes on particular significance. By a corresponding choice of components and their properties, very specifically required filament properties and fleece properties can be set. The high level of variability and in particular the reproducability of these setting possibilities is considerable and surprising.

It is within the framework of the invention that a repositioning unit with at least one diffuser is attached to the stretching unit. Preferably, the relocation unit or the diffuser is formed with several stages, preferably two stages. In accordance with a highly favoured embodiment of the invention, the repositioning unit consists of a first diffuser and a second diffuser attached to this. Preferably, an ambient air entrance gap is provided between the first and the second diffuser. In the first diffuser, there is a reduction of the high air speed required to stretch the filaments at the end of the pulling channel. This results in a clear pressure recovery. Preferably, the opening angle a is infinitely adjustable in a lower divergent area of the first diffuser. In addition, the divergent side walls of the first diffuser are pivotable. This adjustability of the divergent side walls can be symmetrical or asymmetrical in relation to the midplane of the first diffuser. At the start of the second diffuser, an ambient air entrance gap is provided. Due to the high exit impulse from the first diffuser stage, secondary air is sucked from the environment through the ambient air entrance gap. Preferably, the width of the ambient air entrance gap can be set. The ambient air entrance gap can preferably be set here such that the volume flow of the secondary air sucked in is up to 30% of the incoming volume flow of the process air. Advantageously, the second diffuser can have its height adjusted, and this height adjustment is preferably infinitely variable. In this way, the distance from the depositing device and the deposit filter band can be varied. It should be stressed that with the repositioning unit in accordance with the invention, one effective aerodynamic separation between the filament formation area and the depositing area can be achieved from the two diffusers.

It is also basically within the framework of the invention that the unit in accordance with the invention can have a repositioning unit without any air conveyance components or without any diffusers. The filament/air mix then exits from the stretching unit and arrives directly at the depositing device or at the deposit filter band without any air conveyance components.—Furthermore, it is also within the framework of the invention that after exiting from the stretching unit, the filaments are electrostatically effected, and in addition, are conveyed either through a static or a dynamic field. The filaments are charged here so that the filaments are prevented from touching one another. Advantageously, the filaments are then set in motion by a second electric field, and this results in an optimal deposit. Any charge still adhering to the filaments is then, for example, discharged from the filaments by a special conductive deposit filter band and/or by appropriate discharging devices.

It is within the framework of the invention that the depositing device has a continuously moved deposit filter band for the nonwoven web, and at least one suction device provided beneath the deposit filter band. The at least one suction device is preferably in the form of a suction blower. Advantageously, this is at least a controllable and/or adjustable suction blower.—In accordance with a highly favoured embodiment of the invention, at least three suction areas are positioned, one behind the other, in the direction of movement of the deposit filter band, whereby one main suction area is positioned in the depositing area of the nonwoven web, whereby a first suction area is positioned in front of the depositing area, and whereby a second suction area is positioned after the depositing area. The first suction area is therefore positioned in the production direction in front of the depositing area or in front of the main suction area, and the second suction area is positioned after the depositing area or the main suction area in the production direction. Advantageously, the main suction area is separated from the first suction area and from the second suction area by corresponding walls. Preferably, the walls of the main suction area are nozzle-shaped. It is within the framework of the invention that the suction speed in the main suction area is greater than the suction speeds in the first suction area and in the second suction area.

With the unit in accordance with the invention, in comparison to other units known from the prior art, the filament speed and the filament fineness can be considerably increased. Higher filament flow rates and filaments with finer titres can also be achieved. It is possible, without any problem, to reduce the titre to values significantly below 1. With the unit in accordance with the invention, very even, homogeneous nonwoven webs can be produced which are characterised by a high visual quality.—The subject matter of the invention is moreover also a method for producing bi-component and multi-component filaments.

In the following, the invention is described in greater detail using drawings illustrating just one embodiment given as an example. In a schematic representation:

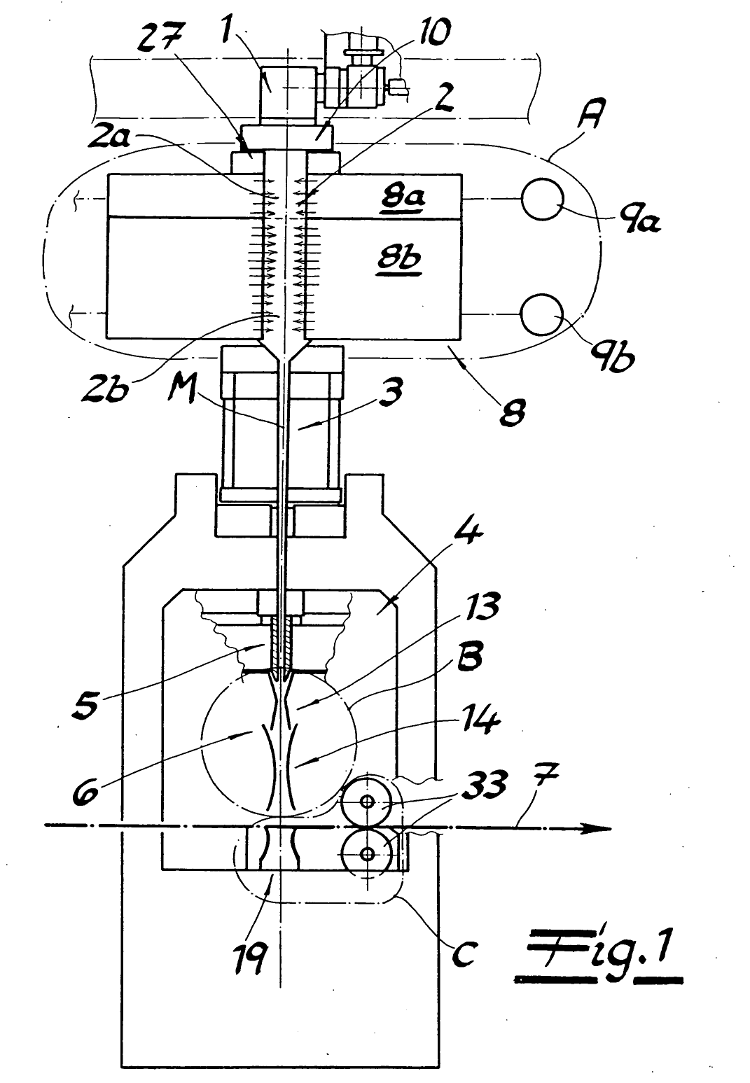

FIG. 1 shows a vertical section through a device in accordance with the invention,

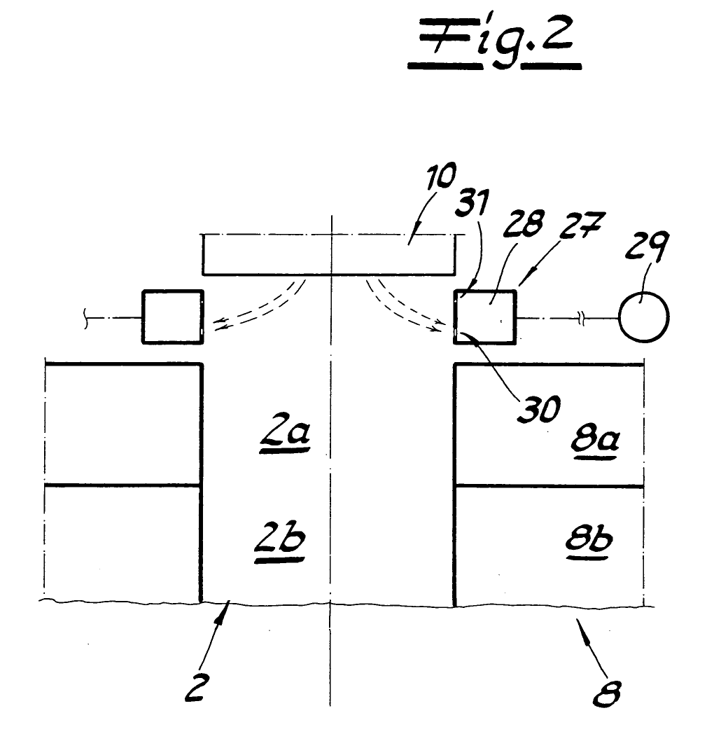

FIG. 2 shows the enlarged section A from the subject matter of FIG. 1,

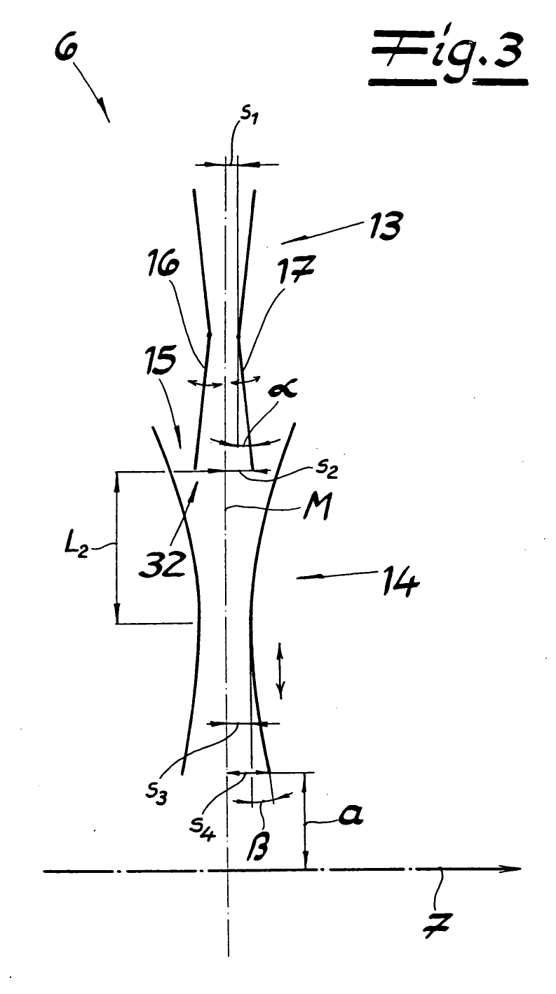

FIG. 3 shows the enlarged section B from the subject matter of FIG. 1,

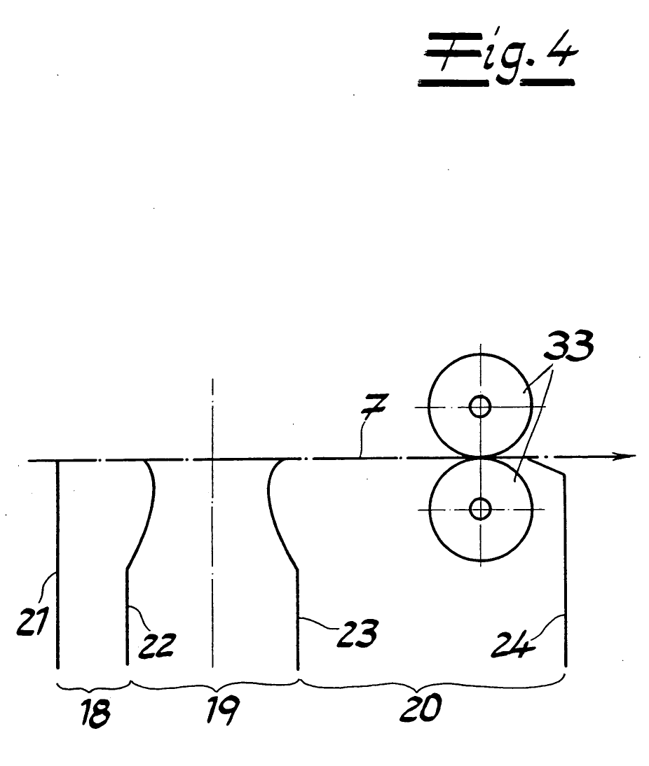

FIG. 4 shows the enlarged section C from the subject matter of FIG. 1,

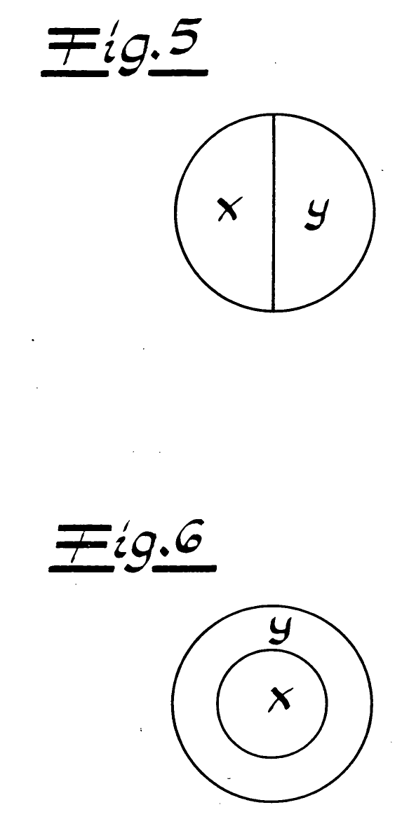

FIG. 5 shows a cross-section through a bi-component filament produced by the device in accordance with the invention, and

FIG. 6 shows the subject matter in accordance with FIG. 5 in another embodiment.

The figures show a device for the continuous production of a nonwoven web from aerodynamically stretched bi-component filaments made from a thermoplastic synthetic. The device has a spinning nozzle 1 and a cooling chamber 2 located beneath the spinning nozzle 1, into which the process air for cooling the filaments can be fed. An intermediary channel 3 is attached to the cooling chamber 2. After the intermediary channel 3, there follows a stretching unit 4 with a pulling channel 5. Attached to the pulling channel 5 there is a repositioning unit 6. Beneath the repositioning unit 6 there is a depositing device in the form of a continuously moved deposit filter band 7 for depositing the filaments to the nonwoven web.

In accordance with the invention, two different polymer fusions can be fed to the spinning nozzle 1 in order to produce bi-component filaments. A non-illustratable device for merging the two polymer fusions is provided such that the bi-component filaments exit from the spinning nozzle openings of the spinning nozzle.

In accordance with a preferred embodiment of the invention, the device in accordance with the invention is used to produce bi-component filaments with a side by side arrangement (FIG. 5). In accordance with another preferred embodiment, the device in accordance with the invention is used to produce bi-component filaments in a core-shell arrangement (FIG. 6). In FIGS. 5 and 6, the different polymers of the bi-component filaments were identified by X and Y.

FIG. 2 shows the cooling chamber 2 of the unit in accordance with the invention, and also the air feed cabin 8 located next to the cooling chamber 2. In the embodiment given as an example, the cooling chamber 2 is divided into an upper cooling chamber section 2a and a lower cooling chamber section 2b. Correspondingly, the air feed cabin 8 is divided into an upper cabin section 8a and a lower cabin section 8b. Process air of a different temperature can be fed from both of the cabin sections 8a, 8b. It is within the framework of the invention that the process air exiting from the upper cabin section 8a has a higher temperature than the process air exiting from the lower cabin section 8b. A setting regulation for these temperatures has already been given above. Moreover, the process air is sucked in by the filaments exiting from the spinning nozzle 1 (not illustrated). Advantageously, and in the embodiment given as an example, a blower 9a, 9b is respectively attached to the cabin sections 8a, 8b for feeding process air. It is within the framework of the invention here that the volume flows of the process air being fed can be regulated. In accordance with the invention, the temperature of the process air respectively entering into the upper cabin section 8a or into the lower cabin section 8b can also be regulated. It is within the framework of the invention that the cabin sections 8a, 8b are located both to the left and to the right of the cooling chamber 2. The left-hand halves of the cabin sections 8a, 8b are also attached to the corresponding blowers 9a, 9b.

FIG. 1 shows that the lower cooling chamber section 2b is three times as long as the upper cooling chamber section 2a. Because the cross-section area of the cooling chamber sections 2a, 2b remains constant in the flow direction of the filaments, the volume of the lower cooling chamber section 2b is also three times as great as the volume of the upper cooling chamber section 2a. This embodiment has proven to be of particular value.

In particular in FIG. 2, it can be seen that a monomer suction device 27 is located between the nozzle plate 10 of the spinning nozzle 1 and the air feed cabin 8, and with this, troublesome gases occurring during the spinning process can be removed from the unit. The monomer suction device 27 has a suction chamber 28 and a suction blower 29 attached to the suction chamber 28. In the lower section of the suction chamber 28 a first suction slit 30 is provided. In accordance with the invention, in the upper section of the suction chamber 28, a second suction slit 31 is also located. Advantageously and in the embodiment given as an example, the second suction slit 31 is narrower than the first suction slit 30. With the additional second suction slit 31, troublesome turbulence between the nozzle plate 10 and the monomer suction device 27 are avoided in accordance with the invention.

In FIG. 1 it can be seen that the intermediary channel 3 from the exit from the cooling chamber 2 to the entrance into the pulling channel 5 of the stretching unit 4 converges in a wedge shape in the vertical section, and advantageously and in the embodiment given as an example to the entrance width of the pulling channel 5. In accordance with a highly favoured embodiment of the invention and in the embodiment given as an example, different gradient angles of the intermediary channel 3 can be set. Preferably and in the embodiment given as an example, the pulling channel 5 converges towards the repositioning unit 6 in a wedge shape in the vertical section. It is within the framework of the invention that the channel width of the pulling channel 5 can be set.

In particular in FIG. 3 it can be seen that the repositioning unit 6 consists of a first diffuser 13 and a second diffuser 14 attached to this, and that an ambient air entrance gap 15 is provided between the first diffuser 13 and the second diffuser 14. FIG. 3 shows that each diffuser 13, 14 has an upper, convergent part as well as a lower divergent part. Consequently, each diffuser 13, 14 has a narrowest point between the upper convergent part and the lower divergent part. In the first diffuser 13 there is a reduction of the high air speeds required to stretch the filaments at the end of the stretching unit 4. This results in a clear recovery of pressure. The first diffuser 13 has a divergent section 32, the side walls 16, 17 of which can be adjusted like flaps. In this way, an opening angle α of the divergent section 32 can be set. This opening angle α is advantageously between 0.5 and 30, and is preferably 1° or approximately 1°. The opening angle α is preferably infinitely variable. The adjustment of the side walls 16, 17 can be both symmetrical and asymmetrical to the midplane M.

At the start of the second diffuser 14, secondary air is sucked in through the ambient air entrance gap 15 in accordance with the injector principle. Due to the high exit impulse of the process air from the first diffuser 13, the secondary air is sucked from the environment through this ambient air entrance gap 15. Advantageously, and in the embodiment given as an example, the width of the ambient air entrance gap 15 can be set. Furthermore, the opening angle β of the second diffuser 14 can preferably be infinitely variable. In addition, the second diffuser 14 is set up such that the height can be adjusted. In this way, the distance a of the second diffuser 14 from the deposit filter band 7 can be set. By means of the height adjustment of the second diffuser 14 and/or by means of the pivotability of the side walls 16, 17 in the divergent section 32 of the first diffuser 13, the width of the ambient air entrance gap 15 can be set. It is within the framework of the invention that the ambient air entrance gap 15 is set so that there is a tangential inflow of the secondary air. Moreover, in FIG. 3 several characteristic dimensions of the repositioning unit 6 are drawn in. The distance s2 between the midplane M and a side wall 16, 17 of the first diffuser 13 is advantageously 0.8 s1 to 2.5 s1 (s1 corresponds here to the distance of the midplane M from the side wall at the narrowest point of the first diffuser 13). The distance s3 of the midplane M from the side wall at the narrowest point of the second diffuser 14 is preferably 0.5 s2 to 2 s2. The distance s4 of the midplane M from the lower edge of the side wall of the second diffuser 14 is 1 s2 to 10 s2. The length L2 has a value of 1 s2 to 15 s2. Different variable values are possible for the width of the ambient air entrance gap 15.

It is within the framework of the invention that the unit comprising the cooling chamber 2, the intermediary channel 3, the stretching unit 4 and the repositioning unit 6 forms a closed system, exclusive of the air suction in the cooling chamber 2 and the air entrance gaps on the repositioning unit 6 and the air entrance on the ambient air entrance gap 15.

FIG. 4 shows a continuously moved deposit filter band 7 for the nonwoven web (not shown). Preferably and in the embodiment given as an example, there are three suction areas 18, 19, 20 positioned behind one another in the direction of movement of the deposit filter band 7. A main suction area 19 is provided in the depositing area of the nonwoven web. A first suction area 18 is located in front of the depositing area or in front of the main suction area 19. A second suction area 20 is disposed behind the main suction area 19. A separate suction blower can basically be allocated to each suction area 18, 19, 20. It is within the framework of the invention, however, that only one suction blower is provided, and that the respective suction conditions are set in the suction areas 18, 19, 20 with the help of positioning and regulating components. The first suction area 18 is defined by the walls 21 and 22. The second suction area 20 is defined by the walls 23 and 24. Preferably and in the embodiment given as an example, the walls 22, 23 of the main suction area 19 form a nozzle contour. The suction speed in the main suction area 19 is advantageously higher than the suction speeds in the first suction area 18 and in the second suction area 20. It is within the framework of the invention that the suction capacity in the main suction area 19 is controlled and/or adjusted independently of the suction capacities in the first suction area 18 and in the second suction area 20. The task of the first suction area 18 consists of discharging the quantities of air fed by the deposit filter band 7 and to align the flow vectors on the boundary of the main suction area 19 orthogonally in relation to the deposit filter band 7. Moreover, the first suction area 18 serves to hold the filaments already deposited here on the deposit filter band 7 so that they function reliably. In the main suction area 19, the air fed along with the filaments must be able to flow freely so that the nonwoven web can be deposited reliably. The second suction area 20, which is disposed behind the main suction area 19, serves to guarantee the conveyance and to secure the deposited nonwoven web on the deposit filter band 7. It is within the framework of the invention that at least one part of the second suction area 20 is located in front of the pressure mating roll 33 in the conveyance direction of the deposit filter band 7. Advantageously, at least one third of the length of the second suction area 20, preferably at least half of the length of the second suction area 20 lies in front of the pressure mating roll 33 in relation to the conveyance direction.

1. Device for the continuous production of a nonwoven web from filaments made from a
thermoplastic synthetic, with a spinning nozzle (1), a cooling chamber (2), a stretching unit (4) and a depositing device for depositing filaments to the nonwoven web,
whereby two or more different polymer fusions can be fed to the spinning nozzle (1), and whereby a device is provided for merging the different polymer fusions such that bi-component filaments and multi-component filaments exit from the spinning nozzle openings of the spinning nozzle (1)
and whereby the cooling chamber (2) is divided into at least two cooling chamber sections (2a, 2b) in which the bi-component filaments and multi-component filaments respectively come into contact with process air with different convective heat discharge means.

2. Device in accordance with claim 1, whereby the device for merging the different polymer fusions
is formed such that the bi-component filaments and multi-component filaments can be produced with a side by side configuration and/or with a core-shell configuration and/or with a segmented pie configuration and/or with an island in the sea configuration.

3. Device in accordance with either of the claims 1 or 2, whereby the bi-component filaments and
multi-component filaments in the at least two cooling chamber sections (2a, 2b) respectively come into contact with process air of a different temperature.

4. Device in accordance with claim 3, whereby the temperature of the process air is higher in a first,
upper cooling chamber section (2a) than the temperature of the process air in a second, lower cooling chamber section (2b) when the device is set up to produce bi-component filaments or multi-component filaments, the components of which consist of polyolefins or of polyolefins and polyesters.

5. Device in accordance with claim 4, whereby the temperature of the process air in the upper
cooling chamber section (2a) is 20 to 45° C., preferably 22 to 40° C, and ideally 25 to 35° C., and whereby the temperature of the process air in the lower cooling chamber section (2b) is 10 to 30° C., preferably 15 to 25° C., and ideally 17 to 23° C. when the device is set up to produce bi-component filaments or multi-component filaments, the components of which consist of polyolefins.

6. Device in accordance with claim 4, whereby the temperature of the process air in the upper
cooling chamber section (2a) is 50 to 90° C., preferably 55 to 85° C., and ideally 60 to 80° C., and whereby the temperature of the process air in the lower cooling chamber section (2b) is 10 to 40° C., preferably 15 to 35° C., and ideally 15 to 25° C. when the device is set up to produce bi-component filaments and multi-component filaments, the components of which consist of polyolefins and polyesters.

7. Device in accordance with claim 3, whereby the temperature of the process air in the first, upper
cooling chamber section (2a) is lower than the temperature of the process air in the second, lower cooling chamber section (2b) when the device is set up to produce bi-component filaments and multi-component filaments, the components of which consist of polylactides and polyolefins, or of polyvinyl alcohols and polyolefins, or of polyvinyl alcohols and polyesters.

8. Device in accordance with claim 7, whereby the temperature of the process air in the first, upper
cooling chamber section (2a) is 7 to 25° C., preferably 10 to 25° C., and ideally 15 to 25° C., and whereby the temperature of the process air in the second, lower cooling chamber section (2b) is 15 to 40° C., preferably 15 to 35° C., and ideally 17 to 25° C.

9. Device in accordance with any of the claims 1 to 8, whereby the exit speed of the process air from
the first, upper cooling chamber section (2a) is lower than the exit speed of the process air from the second, lower cooling chamber section (2b).

10. Device in accordance with claim 9, whereby the ratio v1/v2 of the exit speed v1 of the process air
from the first, upper cooling chamber section (2a) to the exit speed v2 of the process air from the second, lower cooling chamber section (2b) is 0.9 to 0.5, preferably 0.85 to 0.6 and ideally 0.8 to 0.7.

11. Device in accordance with any of the claims 1 to 10, whereby the ratio of the length of the first,
upper cooling chamber section (2a) to the length of the second, lower cooling chamber section (2b) is 0.15 to 0.6, preferably 0.2 to 0.5, and ideally 0.2 to 0.4.
